(19) United States
(12) Patent Application Publication
(10) Pub. No.: US 2026/0065518 A1
(43) Pub. Date: Mar. 5, 2026

(54) UPSIDE DOWN REINFORCEMENT LEARNING FOR TEXT-TO-IMAGE GENERATION

(71) Applicant: ADOBE INC., SAN JOSE, CA (US)

(72) Inventors: Vinh Ngoc Khuc, San Jose, CA (US); Fengbin Chen, Los Gatos, CA (US); Pranav Vineet Aggarwal, Santa Clara, CA (US); Han Guo, Santa Clara, CA (US); Ajinkya Gorakhnath Kale, San Jose, CA (US)

(21) Appl. No.: 18/823,839

(22) Filed: Sep. 4, 2024

(51) Int. Cl. G06T 11/00; G06T 7/00

(52) U.S. Cl. CPC G06T 11/00; G06T 7/0002; G06T 2200/24; G06T 2207/20081; G06T 2207/20084; G06T 2207/30168

(57) ABSTRACT

A method, apparatus, non-transitory computer readable medium, and system for image processing include obtaining an input prompt including an image quality level and a description of an object, generating an image embedding based on the input prompt, where the image embedding represents the object and the image quality level in a vector space, and generating a synthetic image based on the image embedding, where the synthetic image depicts the object and has the image quality level.

### BACKGROUND

The following relates generally to image processing, and more specifically to image generation using a machine learning model. Image processing refers to the use of a computer to edit an image using an algorithm or a processing network. In some cases, image processing software can be used for various image processing tasks, such as image restoration, image detection, image editing, image compositing, and image generation. For example, image generation includes the use of a machine learning model to generate a synthetic image based on an input such as a text prompt, an image, or a style.

### SUMMARY

Aspects of the present disclosure provide a method and system for text-to-image generation. In one aspect, the system receives an input prompt describing an object having an image quality level to generate a synthetic image depicting the object having the same image quality level. According to some aspects, the system includes a diffusion prior model trained to convert a text embedding of the input prompt into an image embedding. In one aspect, the image embedding includes visual feature such as visual appearance of objects, scenes, and spatial arrangement of elements that aligns with the input prompt. In one aspect, an image generation model is configured to generate the synthetic image based on the image embedding.

A method, apparatus, non-transitory computer readable medium, and system for image processing include obtaining an input prompt including an image quality level and a description of an object, generating, using a diffusion prior model, an image embedding based on the input prompt, where the image embedding represents the object and the image quality level in a vector space, and generating, using an image generation model, a synthetic image based on the image embedding, where the synthetic image depicts the object and has the image quality level.

A method, apparatus, non-transitory computer readable medium, and system for image processing include obtaining a training set comprising a training image and a training prompt that includes an image quality level, generating, using an image generation model, a synthetic image based on the training prompt, and training, using the training set and the synthetic image, a diffusion prior model to generate an image embedding that represents the image quality level.

An apparatus and system for image processing include at least one processor, at least one memory storing instructions executable by the at least one processor, a diffusion prior model comprising parameters stored in the at least one memory and trained to generate an image embedding based on an input prompt including an image quality level and a description of an object, where the image embedding represents the object and the image quality level in a vector space, and an image generation model comprising parameters stored in the at least one memory and configured to generate a synthetic image based on the image embedding, where the synthetic image depicts the object and has the image quality level.

### BRIEF DESCRIPTION OF THE DRAWINGS

FIG. 1 shows an example of an image processing system according to aspects of the present disclosure.

FIG. 2 shows an example of a method for text-conditioned image generation according to aspects of the present disclosure.

FIG. 3 shows an example of text-to-image generation according to aspects of the present disclosure.

FIG. 4 shows an example of a method for generating a synthetic image based on an augmented text prompt according to aspects of the present disclosure.

FIG. 5 shows an example of an image processing apparatus according to aspects of the present disclosure.

FIG. 6 shows an example of a machine learning model according to aspects of the present disclosure.

FIG. 7 shows an example of an image generation model according to aspects of the present disclosure.

FIG. 8 shows an example of a U-Net architecture according to aspects of the present disclosure.

FIG. 9 shows an example of a diffusion process according to aspects of the present disclosure.

FIG. 10 shows an example of a method for obtaining an input prompt according to aspects of the present disclosure.

FIG. 11 shows an example of a method for training a diffusion prior model according to aspects of the present disclosure.

FIG. 12 shows an example of upside-down reinforcement learning (UDRL) according to aspects of the present disclosure.

FIG. 13 shows an example of training a diffusion prior model according to aspects of the present disclosure.

FIG. 14 shows an example flowchart diagram illustrating an algorithm as a step-by-step procedure in an example implementation of operations performable for training a machine learning model according to aspects of the present disclosure.

FIG. 15 shows an example of a method for training a diffusion model according to aspects of the present disclosure.

FIG. 16 shows an example of a computing device according to aspects of the present disclosure.

### DETAILED DESCRIPTION

The following relates to text-to-image generation using generative machine learning. Embodiments of the disclosure relate to an image generation system that accurately generates images having an image quality level consistent with the text description.

In one aspect, the system includes a diffusion prior model trained using upside-down reinforcement learning (UDRL). That is, during training the image quality level of a corresponding training image (i.e., the value corresponding to the reinforcement learning target or reward) is directly provided to the diffusion prior model as an input to generate an image embedding. The image embedding includes information that relates the text description and the image quality level of the training image. The image embedding is provided to an image generation model to ensure that the synthetic image is accurately generated and has an image quality level consistent with the text description.

According to some embodiments, the system receives an input prompt describing an object and an image quality level and generates a synthetic image depicting the object having the image quality level. In some aspects, the system includes a diffusion prior model trained using UDRL to convert a text embedding of the input prompt into an image embedding. In one aspect, the image embedding includes visual features such as visual appearance of objects, scenes, and spatial arrangement of elements that aligns with the input prompt. In one aspect, an image generation model is configured to generate the synthetic image based on the image embedding.

For example, the input prompt states “Aesthetic 6.0; black horse.” A text encoder encodes the input prompt to generate a text embedding. For example, the text embedding may represent the input prompt in a numerical vector, where each value or a group of values represents each word or a group of words in the input prompt. Then, the trained diffusion prior model converts the text embedding into an image embedding. For example, the image embedding may include visual information such as color feature, color intensity, texture feature, shapes, edges, relative spatial relationships, and high-level semantic features of black horse in numerical representations. In some cases, the image embedding may correlate the image quality level and the visual information. For example, a high image quality level (e.g., aesthetic 6.0) indicates an enhanced visual information of the black horse while a low image quality level (e.g., aesthetic 2.0) indicates a poor visual information of the black horse. Then, using the image embedding, the image generation model is able to accurately generate the synthetic image depicting a black horse having the image quality level consistent with the input prompt.

In the field of image processing, a machine learning model is trained to generate synthetic images based on an input conditioning such as a text prompt. In some cases, the machine learning model is trained using various training techniques. For example, in supervised learning, a machine learning model is trained on labeled data which maps an input to an output based on the labeled data. After training the machine learning model, the machine learning model is able to generalize from the training data to unseen examples. However, the performance of the trained machine learning model is dependent on the training data such as data quality and data variation.

Another training technique refers to unsupervised training. In unsupervised training, a machine learning model is trained using unlabeled data. In some cases, unsupervised learning is particularly useful in finding hidden patterns or grouping in data, such as cluster analysis. However, without labeled data, the quality of the result can be challenging to assess. In some cases, the training machine learning model might not be able to scale well with large datasets. In some cases, high-dimensional data may introduce complications in the learning process.

Another training technique refers to reinforcement learning. For example, reinforcement learning relates to how software agents make decisions to maximize a reward. Reinforcement learning strikes a balance between exploring unknown options and exploiting existing knowledge. In some cases, a reinforcement learning environment is framed as a Markov decision process (MDP). Many reinforcement learning algorithms include dynamic programming techniques. A difference between reinforcement learning and conventional dynamic programming methods is that reinforcement learning does not require an exact mathematical model of the MDP. Accordingly, reinforcement learning is suitable for large MDPs where exact methods are impractical.

However, reinforcement learning algorithms may be computationally expensive to train an image generation model due to the large number of trainings and vast amount of training data to converge an optimal policy. As a result, the training time may be extended along with increased computational resources. In addition, performing large-scale image processing tasks without significant resources may be impractical. In some cases, reinforcement learning algorithms can be unstable and might not converge to an optimal result. Thus, the trained machine learning model may result in inconsistent performance and unreliable outcomes (e.g., image generations) in image processing applications. In some cases, conventional techniques require individually training several models (e.g., text encoder, image encoder, and image generation model) based on partitioned datasets. However, by training each model on a smaller subset of the training data, the overall performance may decrease.

Accordingly, embodiments of the disclosure improve on conventional image generation models by generate more accurate images that aligns with the image quality level described in the input prompt. This is achieved using a diffusion prior model that is trained using UDRL to convert a text embedding into an image embedding. For example, the image embedding directly correlates the image quality level from the input prompt to the visual information in the image embedding. The image embedding generated by the trained diffusion prior model includes more accurate relationship between the image quality level and visual elements to be generated in the synthetic image. Thus, the system can accurately generate a synthetic image that aligns with the input prompt and reflects the target image quality level.

In one aspect, the system includes a diffusion prior model trained using UDRL by providing a “reward” (e.g., an image quality level) to be part of the input conditioning for an image generation model. In some cases, an aesthetic classifier is used to generate the image quality level based on a training image. By combining the known image quality level of a training image along with a text prompt that describes the content of the training image to obtain the input prompt, the diffusion prior model can accurately generate an image embedding based on a text embedding of the input prompt.

Accordingly, the diffusion prior model is able to learn and generate an image embedding that includes the visual appearance corresponding to a certain image quality level based on a text input describing the image quality level. For example, given an input prompt that states “aesthetic 6.0, white tiger”, the diffusion prior model is able to generate an image embedding having visual information of a white tiger with a high image quality level. For example, visual elements affecting the image quality level may include an overall visual appearance of an image such as resolution, composition, mood, theme, color, lighting, texture, focus, contrast, style, image detail, and/or context. Then, an image generation model is able to generate an accurate image depicting the white tiger with a high image quality level based on the image embedding.

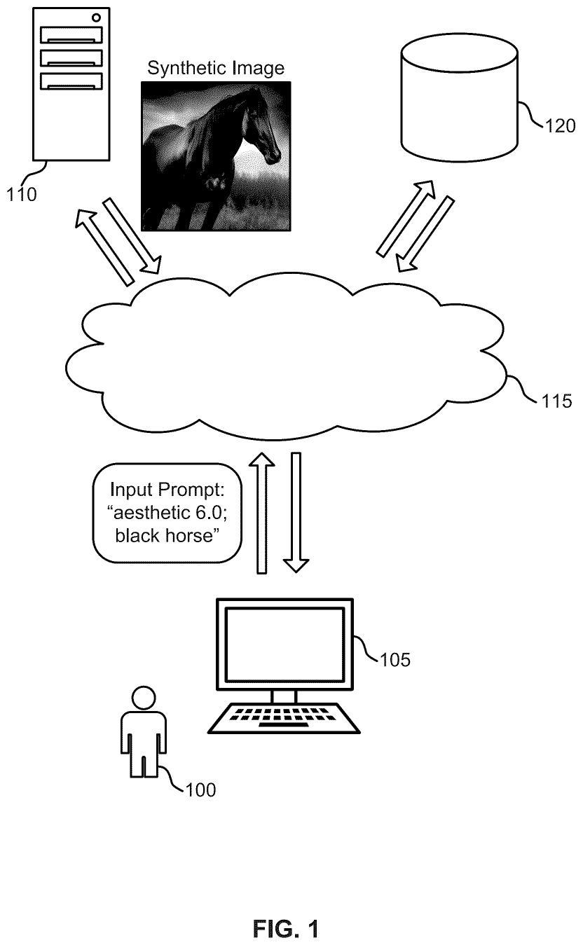

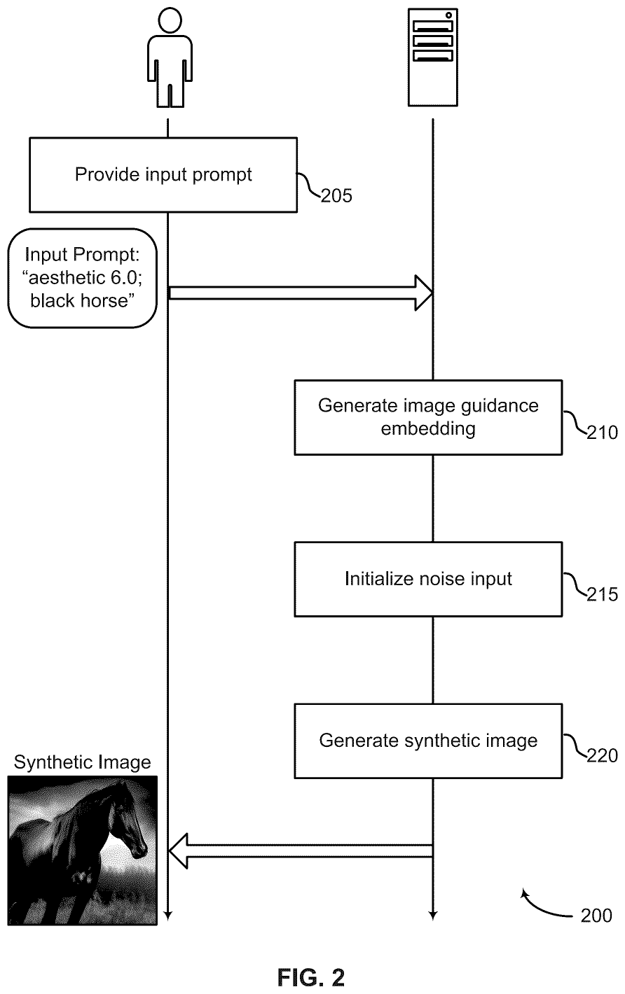

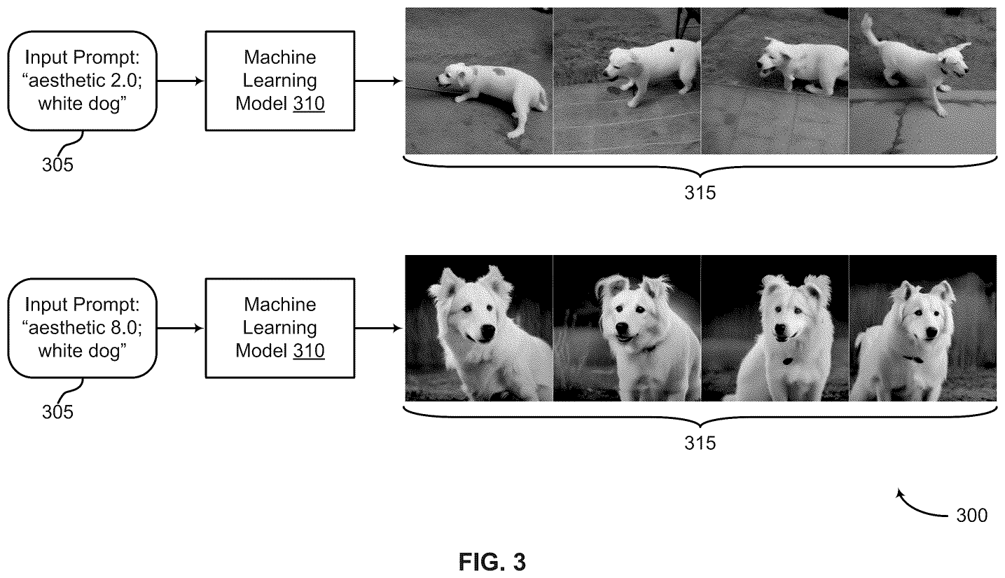

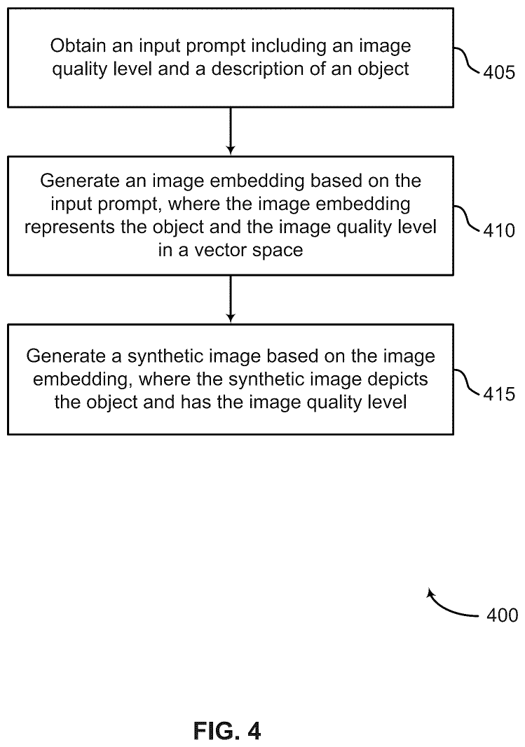

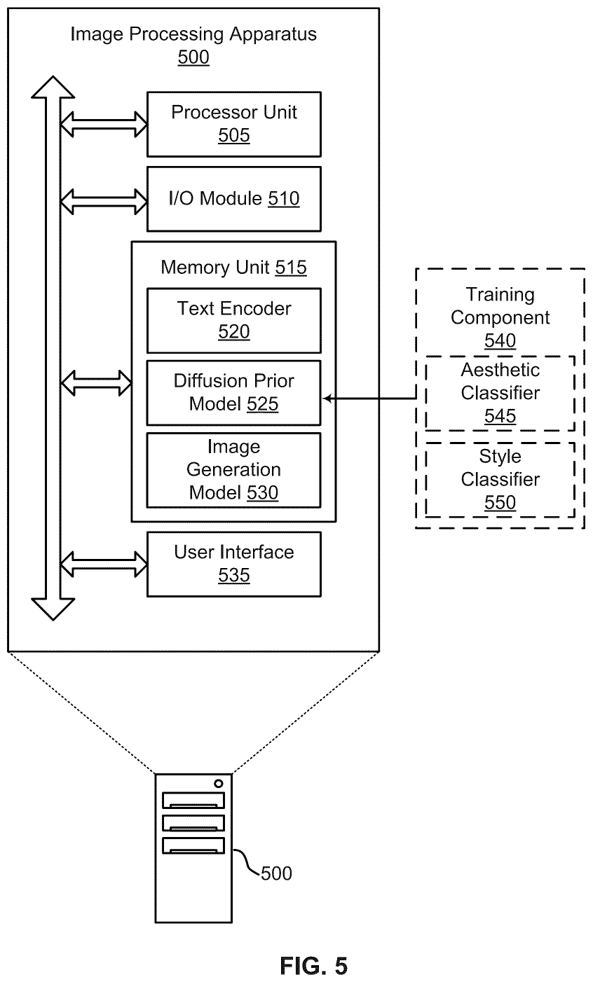

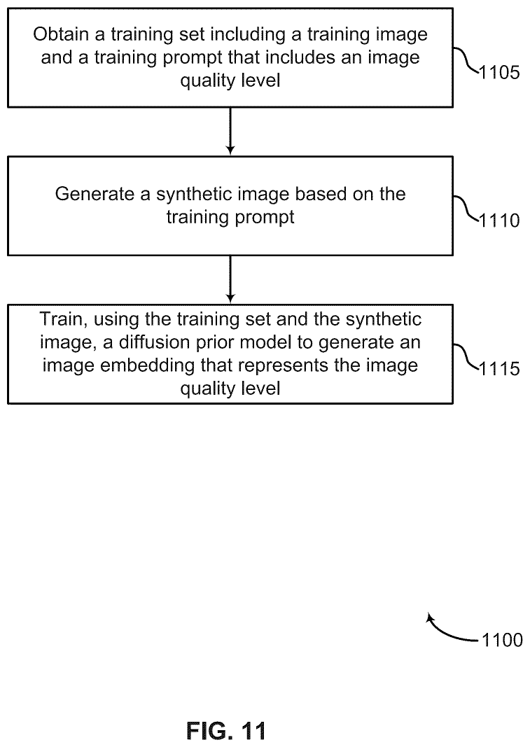

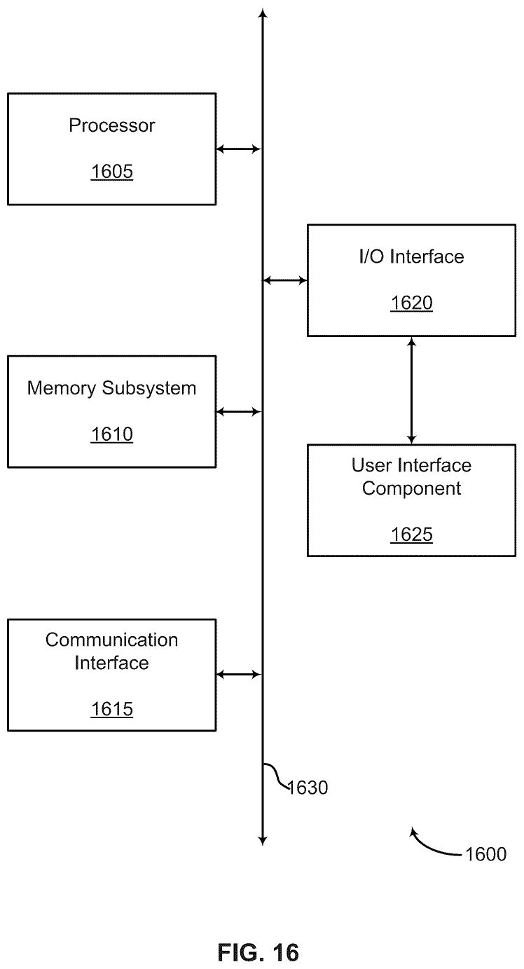

An example system of the inventive concept in image processing is provided with reference to FIGS. 1 and 16. An example application of the inventive concept in image processing is provided with reference to FIGS. 2-3. Details regarding the architecture of an image processing apparatus are provided with reference to FIGS. 5-8. An example of a process for image processing is provided with reference to FIGS. 4 and 9-10. An example training process is provided with reference to FIGS. 11-15.

Accordingly, the present disclosure provides a system and method that improve on conventional image generation models by generating images more accurately and efficiently. In some embodiments, an image generation model operates based on an input prompt describing the content of the synthetic image having an image quality level. Specifically, by training a diffusion prior model using UDRL to generate an image embedding based on a text embedding of an input prompt, the image embedding can include visual information that directly correlates visual elements to a value of the image quality level from the input prompt. In some aspects, by training the diffusion prior model using UDRL, computational resources used for training can be reduced. By generating the synthetic image based on an image embedding instead of a text embedding of the input prompt, the image generation model can accurately and efficiently generate the synthetic image having intricate visual details that aligns with the input prompt.

### Text-to-Image Generation

In FIGS. 1-4 and 9-10, a method, apparatus, non-transitory computer readable medium, and system for image processing include obtaining an input prompt including an image quality level and a description of an object, generating, using a diffusion prior model, an image embedding based on the input prompt, where the image embedding represents the object and the image quality level in a vector space, and generating, using an image generation model, a synthetic image based on the image embedding, where the synthetic image depicts the object and has the image quality level.

Some examples of the method, apparatus, non-transitory computer readable medium, and system further include obtaining a preliminary prompt and an indication of the image quality level. Some examples further include generating the input prompt based on the preliminary prompt and the indication. Some examples of the method, apparatus, non-transitory computer readable medium, and system further include obtaining a style input. In some cases, the input prompt includes a value indicating a level of a style corresponding to the style input.

Some examples of the method, apparatus, non-transitory computer readable medium, and system further include generating a text embedding based on the input prompt. In some cases, the image embedding is generated based on the text embedding. Some examples of the method, apparatus, non-transitory computer readable medium, and system further include obtaining a noise map. Some examples further include denoising the noise map based on the image embedding to generate the synthetic image. In some aspects, the diffusion prior model is trained to generate image embeddings using a training set comprising a training image and a training prompt that includes the image quality level.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 5.

Referring to FIG. 1, user 100 provides an input prompt to image processing apparatus 110 via user device 105 and cloud 115 to generate a synthetic image. In some cases, user 100 provides a text prompt and a value for an aesthetic level to image processing apparatus 110. Image processing apparatus 110 combines the text prompt and the value to obtain the input prompt. In some embodiments, image processing apparatus 110 includes a machine learning model that generates a text embedding based on the input prompt. Then, the machine learning model converts the text embedding into an image embedding for an image generation model. The image generation model generates a synthetic image based on the image embedding. In one aspect, the synthetic image depicts contents described by the text prompt and has an aesthetic appearance corresponding to the value.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

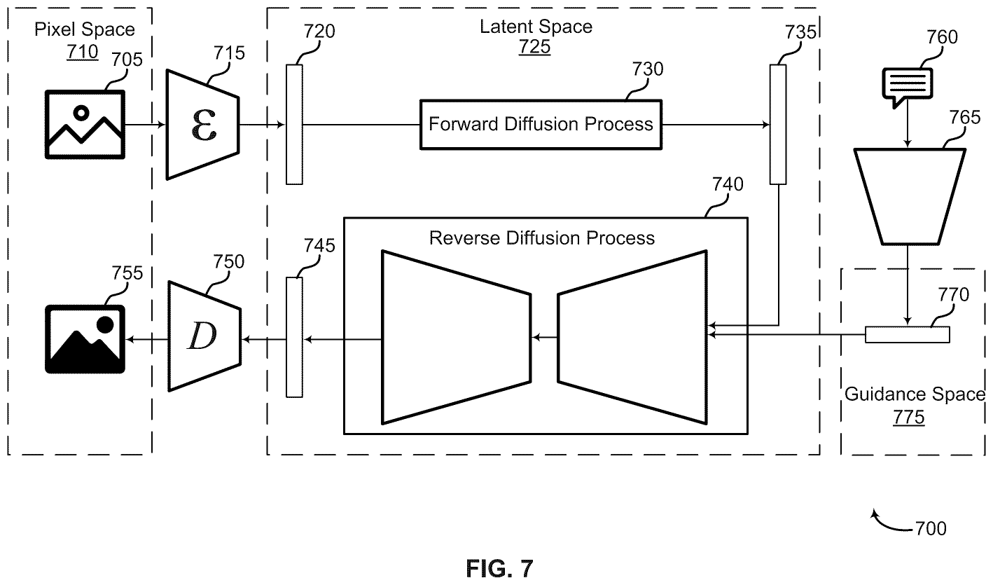

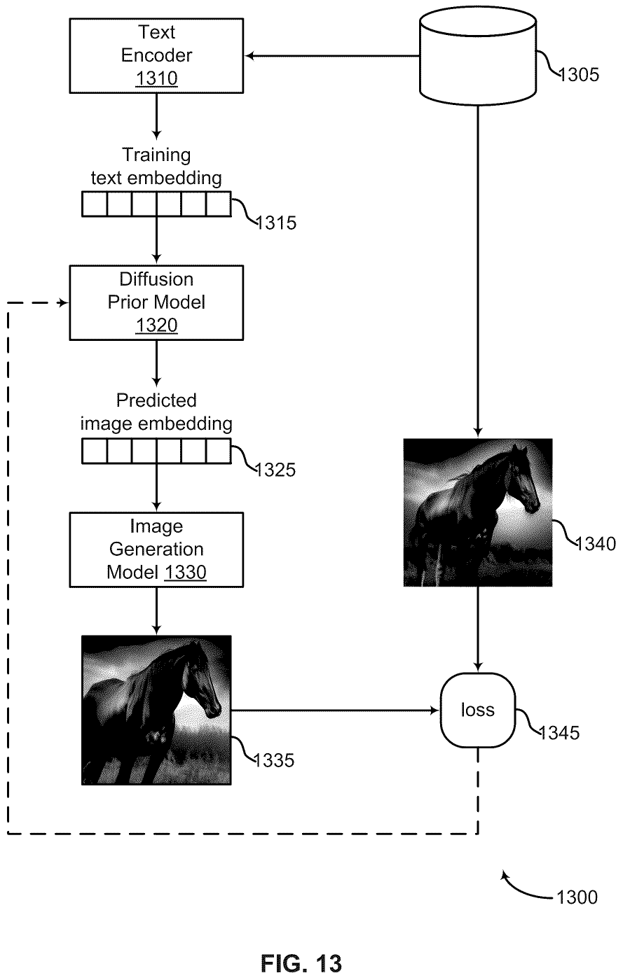

Image processing apparatus 110 is an example of, or includes aspects of, the corresponding element described with reference to FIG. 7. According to some aspects, image processing apparatus 110 includes a computer implemented network comprising a machine learning model, a text encoder, a diffusion prior model, and an image generation model. In some embodiments, image processing apparatus 110 includes a training component, an aesthetic classifier, and a style classifier. Image processing apparatus 110 further includes a processor unit, a memory unit, and an I/O module. In some embodiments, image processing apparatus 110 further includes a communication interface, user interface components, and a bus as described with reference to FIG. 13. Additionally or alternatively, image processing apparatus 110 communicates with user device 105 and database 120 via cloud 115. Further detail regarding the operation of image processing apparatus 110 is described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data including a training image and a training prompt having an image quality level. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for text-conditioned image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, a user (e.g., the user described with reference to FIG. 1) provides a text prompt (also referred to as the input prompt) to the image processing apparatus (e.g., the image processing apparatus described with reference to FIGS. 1 and 5) to generate a synthetic image. For example, the input prompt states “aesthetic 6.0; black horse”. In some cases, the user provides a preliminary prompt and a value indicating an image quality level to the image process apparatus. For example, the preliminary prompt describes the content to be generated in the synthetic image. For example, the value of the image quality level represents an aesthetic appearance of the synthetic image. In some embodiments, the image processing apparatus combines the preliminary prompt and the value of the image quality level to obtain the input prompt.

In some embodiments, the image processing apparatus includes a text encoder that takes the input prompt to generate a text embedding. In some cases, the text embedding includes textual information of the text prompt. In some aspects, the image process apparatus includes a diffusion prior model trained to convert the text embedding into an image embedding. For example, the image embedding captures visual features to be generated in the synthetic image. In some cases, the image embedding includes additional information that enables an image generation model to generate an accurate synthetic image that aligns with the input prompt. The synthetic image is displayed to the user via the image processing apparatus.

At operation 205, the user provides an input prompt to the system. In some cases, the operations of this step refer to, or may be performed by, a user as described with reference to FIG. 1. In some cases, the user provides an input prompt that describes the content having a certain image quality level to be generated in a synthetic image. For example, a user provides the input prompt “aesthetic 6.0; black horse” to the image processing apparatus. For example, aesthetic 6.0 indicates a relatively high image quality. In some cases, image quality refers to factors that may impact the overall visual appearance of an image such as resolution, composition, mood, theme, color, lighting, texture, focus, contrast, style, and/or context. In some cases, the input prompt is used as a guidance to an image generation model. In some examples, guidance can be provided in a form other than text, such as via an image, a sketch, or a layout.

At operation 210, the system generates image guidance embedding. In some cases, the operations of this step refer to, or may be performed by, an image processing apparatus as described with reference to FIGS. 1 and 5. In some cases, the operations of this step refer to, or may be performed by, a diffusion prior model as described with reference to FIGS. 5, 6, 12, and 13. In some embodiments, a text encoder encodes the input prompt to generate a text embedding or other multi-dimensional representations. For example, the input prompt may be encoded into a text embedding (e.g., a vector) or a series of vectors using a text encoder, a transformer model, or a multi-modal encoder. Then, the diffusion prior model converts the text embedding into an image embedding (or image guidance embedding). In some cases, the text encoder for generating the text embedding is pre-trained. In some cases, the diffusion prior model is trained independently of the image generation model.

At operation 215, the system initializes noise input. In some cases, the operations of this step refer to, or may be performed by, an image processing apparatus as described with reference to FIGS. 1 and 5. In some cases, the operations of this step refer to, or may be performed by, an image generation model as described with reference to FIGS. 5, 6, and 13. In some cases, the noise input including random noise is initialized. The noise input may be in a pixel space or a latent space. By initializing the image generation model with random noise, different variations of a synthetic image including the content described by the text conditioning (e.g., the input prompt) can be generated.

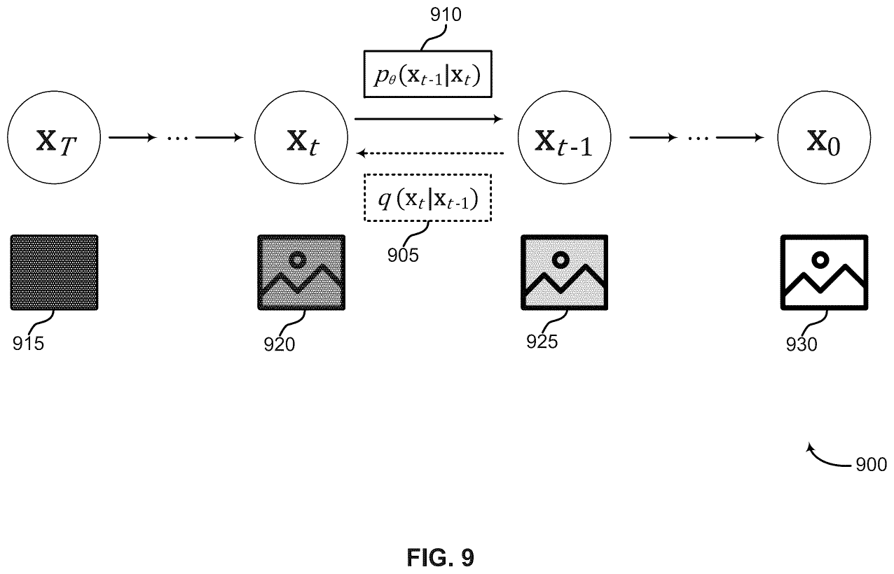

At operation 220, the system generates the synthetic image. In some cases, the operations of this step refer to, or may be performed by, an image processing apparatus as described with reference to FIGS. 1 and 5. In some cases, the operations of this step refer to, or may be performed by, an image generation model as described with reference to FIGS. 5, 6, and 13. For example, the image generation model generates a synthetic image based on the image embedding. In some aspects, the image embedding includes visual features described by the input prompt. In some cases, the image embedding includes visual features that correspond to a value of the image quality level described by the input prompt. For example, the synthetic image may be generated using a reverse diffusion process as described with reference to FIG. 9. Then, the synthetic image is returned and displayed to the user via a user interface provided by the image processing apparatus on the user device.

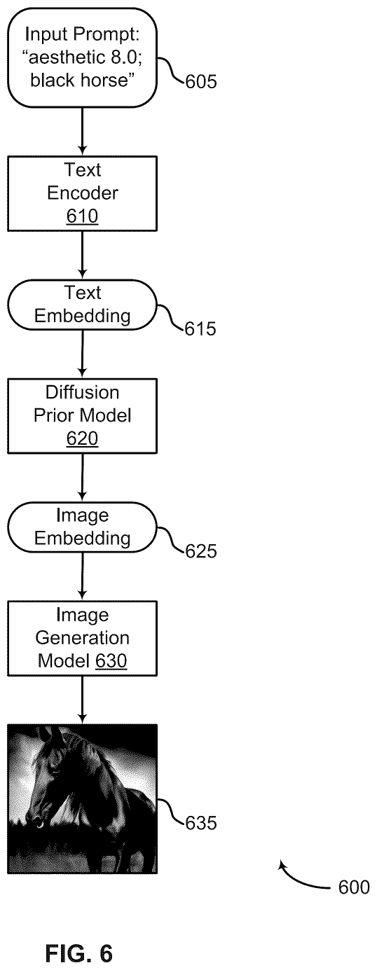

FIG. 3 shows an example of text-to-image generation according to aspects of the present disclosure. The example shown includes image generation system 300, input prompt 305, machine learning model 310, and synthetic images 315. In some aspects, image generation system 300 is implemented in a user interface described with reference to FIG. 5. Input prompt 305 is an example of, or includes aspects of, the corresponding element described with reference to FIG. 6.

Referring to FIG. 3, machine learning model 310 receives input prompt 305 to generate synthetic images 315. For example, input prompt 305 states “aesthetic 2.0; white dog”. In some aspects, machine learning model 310 includes a text encoder configured to encode input prompt 305 to generate a text embedding. In some aspects, machine learning model 310 includes a diffusion prior model trained to convert the text embedding into an image embedding. In some cases, the image embedding includes visual features described by input prompt 305. For example, the image embedding may include visual features having visual information such as low image resolution, a level of aesthetic appearance that corresponds to a low value of 2.0, fewer details, poor composition, etc. Then, an image generation model is used to generate synthetic images 315 based on the image embedding. For example, synthetic images 315 depicts four variations of a white dog having a low aesthetic appearance (corresponding to the aesthetic score of 2.0). However, embodiments of the present disclosure are not necessarily limited hereto. For example, synthetic images 315 may include one or more images.

In some cases, for example, machine learning model 310 receives input prompt 305 indicating a high image quality level to generate synthetic images 315 having high image qualities. For example, input prompt 305 states “aesthetic 8.0; white dog”. In some cases, machine learning model 310 generates a text embedding based on input prompt 305. Then, machine learning model 310 converts the text embedding into an image embedding. For example, the image embedding includes visual features having visual information such as high image resolution, a level of aesthetic appearance that corresponds to a high value of 8.0, more details, etc. Then, an image generation model is configured to generate synthetic images 315 based on the image embedding. For example, synthetic images 315 depicts four variations of the white dog having a high aesthetic appearance (e.g., corresponding to the aesthetic score of 8.0).

FIG. 4 shows an example of a method 400 for generating a synthetic image based on an augmented text prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the system obtains an input prompt including an image quality level and a description of an object. In some cases, the operations of this step refer to, or may be performed by, a text encoder as described with reference to FIGS. 5-7, 12, and 13. In some cases, the input prompt includes a preliminary prompt and an indication of the image quality level. For example, the preliminary prompt describes the content to be generated in the synthetic image. For example, the indication of the image quality level may include a value representing the image quality level. In some cases, image quality level refers to factors that may impact the overall visual appearance of an image such as resolution, composition, mood, theme, color, lighting, texture, focus, contrast, style, and/or context. For example, the image quality level includes an aesthetic score. A higher aesthetic score represents a higher image quality and a lower aesthetic score represents a lower image quality. In some cases, the input prompt may be a text prompt, a voice prompt, an image prompt, a video prompt, or a combination thereof.

In some cases, the system obtains a style input including a value indicating a level of a style. For example, the style input may include a vector classifier score that indicates a vectorization of the synthetic image. For example, the higher the vector classifier score, the synthetic image has more of a vectorized appearance. In some cases, the style input may include other types of styles such as cartoon style, painting style, etc.

At operation 410, the system generates an image embedding based on the input prompt, where the image embedding represents the object and the image quality level in a vector space. In some cases, the operations of this step refer to, or may be performed by, a diffusion prior model as described with reference to FIGS. 5, 6, 12, and 13. In some cases, for example, the system includes a text encoder (or a pre-trained text encoder) configured to generate a text embedding based on the input prompt. Then, a diffusion prior model is trained to convert the text embedding into the image embedding. In some cases, a text embedding may be represented as a vector form in a text embedding space. Vector space provides a framework for representing and manipulating data (in the form of vectors), computing distances between vectors, and transforming input data for complex relationships. The dimensionality of the vector space is determined by the number of features in the feature vector. For example, if each data point has three features (e.g., length, width, and height), the vector space is three-dimensional. In some cases, a joint vector space includes a high-dimensional vector space and a low-dimensional vector space. In some cases, the text embedding is in a low-dimensional vector space. In some cases, an image embedding is in a high-dimensional vector space.

In some cases, an image embedding includes additional information than the text embedding. For example, a text embedding captures the semantic meanings of the input prompt, whereas image embeddings capture visual features and patterns. In some cases, the text embedding may be represented as a string vector (e.g., 1-dimensional), whereas image embedding may be represented as numerical arrays (e.g., 2-dimensional). In some cases, image embedding includes visual information about the content and the image quality level of the synthetic image to be generated.

At operation 415, the system generates a synthetic image based on the image embedding, where the synthetic image depicts the object and has the image quality level. In some cases, the operations of this step refer to, or may be performed by, an image generation model as described with reference to FIGS. 5, 6, and 13.

### System Architecture

In FIGS. 5-8 and 16, an apparatus and system for image processing include at least one processor, at least one memory storing instructions executable by the at least one processor, a diffusion prior model comprising parameters stored in the at least one memory and trained to generate an image embedding based on an input prompt including an image quality level and a description of an object, where the image embedding represents the object and the image quality level in a vector space, and an image generation model comprising parameters stored in the at least one memory and configured to generate a synthetic image based on the image embedding, where the synthetic image depicts the object and has the image quality level.

Some examples of the apparatus and system further include a text encoder configured to generate a text embedding based on the input prompt, where the image embedding is generated based on the text embedding. In some aspects, the diffusion prior model includes a diffusion model. In some aspects, the image generation model includes a diffusion model.

Some examples of the apparatus and system further include an aesthetic classifier configured to compute the image quality level. Some examples of the apparatus and system further include a style classifier configured to compute a value indicating a level of a style, where the input prompt includes the level of the style. Some examples of the apparatus and system further include a user interface configured to obtain a preliminary prompt, where the input prompt is based on the preliminary prompt and the image quality level.

FIG. 5 shows an example of an image processing apparatus 500 according to aspects of the present disclosure. The example shown includes image processing apparatus 500, processor unit 505, I/O module 510, memory unit 515, user interface 535, and training component 540. In one aspect, memory unit 515 includes text encoder 520, diffusion prior model 525, and image generation model 530. In one aspect, training component 540 includes aesthetic classifier 545 and style classifier 550.

According to some embodiments of the present disclosure, image processing apparatus 500 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 500 is an example of, or includes aspects of, the corresponding element described with reference to FIG. 1.

Processor unit 505 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 505 is configured to operate a memory array using a memory controller. In other cases, a memory controller is integrated into the processor. In some cases, processor unit 505 is configured to execute computer-readable instructions stored in a memory to perform various functions. In some embodiments, processor unit 505 includes special-purpose components for modem processing, baseband processing, digital signal processing, or transmission processing. Processor unit 505 is an example of, or includes aspects of, the processor described with reference to FIG. 16.

I/O module 510 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 510 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 510 is an example of, or includes aspects of, the I/O interface described with reference to FIG. 16.

Examples of memory unit 515 include random access memory (RAM), read-only memory (ROM), or a hard disk. Examples of memory unit 515 include solid-state memory and a hard disk drive. In some examples, memory unit 515 is used to store computer-readable, computer-executable software including instructions that, when executed, cause a processor to perform various functions described herein.

In some cases, memory unit 515 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 515 store information in the form of a logical state.

According to some aspects, memory unit 515 includes a machine learning model. In one aspect, the machine learning model includes text encoder 520, diffusion prior model 525, and image generation model 530. Memory unit 515 is an example of, or includes aspects of, the memory subsystem described with reference to FIG. 16.

In some cases, a machine learning model is a computational algorithm, model, or system designed to recognize patterns, make predictions, or perform a specific task (for example, image processing) without being explicitly programmed. According to some aspects, the machine learning model is implemented as software stored in memory unit 515 and executable by processor unit 505, as firmware, as one or more hardware circuits, or as a combination thereof.

According to some embodiments of the present disclosure, the machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, the machine learning model includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behaviors and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering the relevance of each input element with respect to the current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, text encoder 520 is implemented as software stored in memory unit 515 and executable by processor unit 505, as firmware, as one or more hardware circuits, or as a combination thereof. According to some aspects, text encoder 520 obtains an input prompt including an image quality level and a description of an object. In some examples, text encoder 520 obtains a preliminary prompt and an indication of the image quality level. In some examples, text encoder 520 generates the input prompt based on the preliminary prompt and the indication. In some examples, text encoder 520 obtains a style input, where the input prompt includes a value indicating a level of a style corresponding to the style input. In some examples, text encoder 520 generates a text embedding based on the input prompt, where the image embedding is generated based on the text embedding.

According to some aspects, text encoder 520 obtains a preliminary prompt and the image quality level. In some examples, text encoder 520 generates the training prompt based on the preliminary prompt and the image quality level. In some examples, text encoder 520 obtains a style input, where the training prompt includes a value indicating a level of a style corresponding to the style input. In some examples, text encoder 520 generates a text embedding based on the training prompt. According to some aspects, text encoder 520 is configured to generate a text embedding based on the input prompt, where the image embedding is generated based on the text embedding. Text encoder 520 is an example of, or includes aspects of, the corresponding element described with reference to FIGS. 6, 7, 12, and 13.

According to some aspects, diffusion prior model 525 is implemented as software stored in memory unit 515 and executable by processor unit 505, as firmware, as one or more hardware circuits, or as a combination thereof. According to some aspects, diffusion prior model 525 generates an image embedding based on the input prompt, where the image embedding represents the object and the image quality level in a vector space. In some aspects, the diffusion prior model 525 is trained to generate image embeddings using a training set including a training image and a training prompt that includes the image quality level.

According to some aspects, diffusion prior model 525 generates an estimated image embedding based on the text embedding. According to some aspects, diffusion prior model 525 comprises parameters stored in the at least one memory and trained to generate an image embedding based on an input prompt including an image quality level and a description of an object, where the image embedding represents the object and the image quality level in a vector space. In some aspects, the diffusion prior model 525 includes a diffusion model. Diffusion prior model 525 is an example of, or includes aspects of, the corresponding element described with reference to FIGS. 6, 12, and 13.

According to some aspects, image generation model 530 is implemented as software stored in memory unit 515 and executable by processor unit 505, as firmware, as one or more hardware circuits, or as a combination thereof. According to some aspects, image generation model 530 generates a synthetic image based on the image embedding, where the synthetic image depicts the object and has the image quality level. In some examples, image generation model 530 obtains a noise map. In some examples, image generation model 530 denoises the noise map based on the image embedding to generate the synthetic image.

According to some aspects, image generation model 530 generates a synthetic image based on the training prompt. In some examples, image generation model 530 generates the synthetic image based on the estimated image embedding. According to some aspects, image generation model 530 comprises parameters stored in the at least one memory and configured to generate a synthetic image based on the image embedding, where the synthetic image depicts the object and has the image quality level. In some aspects, the image generation model 530 includes a diffusion model. Image generation model 530 is an example of, or includes aspects of, the corresponding element described with reference to FIGS. 6 and 13.

According to some aspects, user interface 535 is implemented as software stored in memory unit 515 and executable by processor unit 505, as firmware, as one or more hardware circuits, or as a combination thereof. According to some aspects, user interface 535 is configured to obtain a preliminary prompt, wherein the input prompt is based on the preliminary prompt and the image quality level. User interface 535 is an example of, or includes aspects of, the user interface component described with reference to FIG. 16.

According to some aspects, training component 540 is implemented as software stored in memory unit 515 and executable by processor unit 505, as firmware, as one or more hardware circuits, or as a combination thereof. According to some embodiments, training component 540 is implemented as software stored in a memory unit and executable by a processor in the processor unit of a separate computing device, as firmware in the separate computing device, as one or more hardware circuits of the separate computing device, or as a combination thereof. In some examples, training component 540 is part of another apparatus other than image processing apparatus 500 and communicates with the image processing apparatus 500. In some examples, training component 540 is part of image processing apparatus 500.

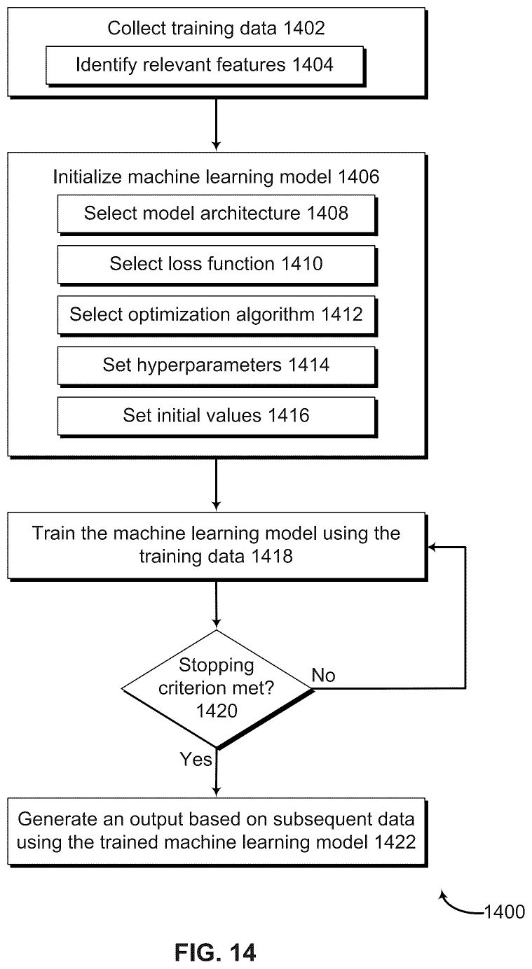

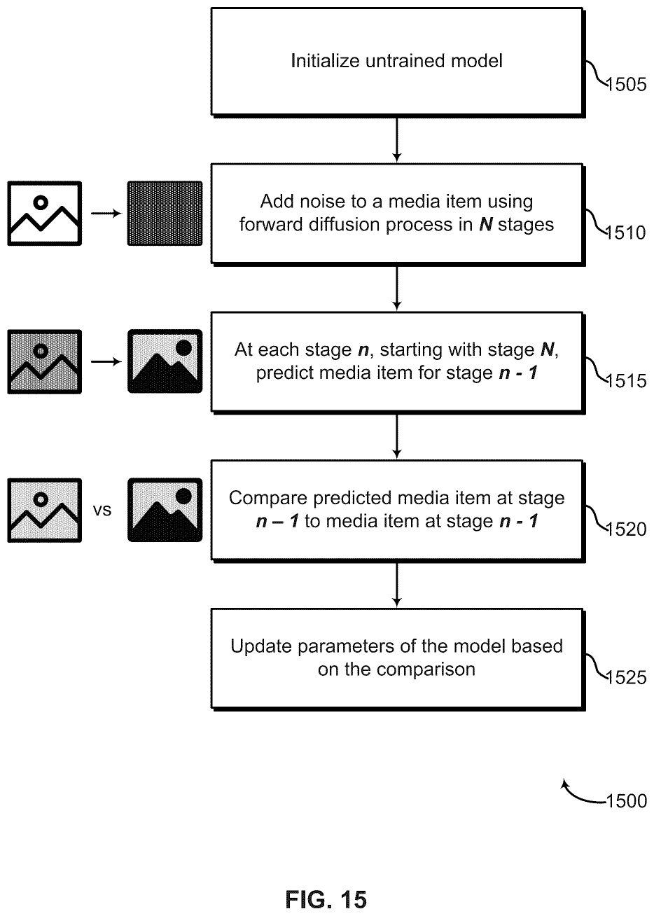

According to some embodiments, training component 540 may train the diffusion prior model 525. For example, parameters of the diffusion prior model 525 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 14 and 15). The goal of the training process may be to find optimal values for the parameters that allow the machine learning model to make accurate predictions or perform well on the given task.

Accordingly, the node weights can be adjusted to improve the accuracy of the output (e.g., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion prior model 525 can be used to make predictions on new, unseen data (e.g., during inference).

According to some aspects, training component 540 obtains a training set including a training image and a training prompt that includes an image quality level. In some examples, training component 540 trains, using the training set and the synthetic image, a diffusion prior model 525 to generate an image embedding that represents the image quality level. In some examples, training component 540 computes a diffusion loss based on the synthetic image. In some examples, training component 540 updates parameters of the diffusion prior model 525 based on the diffusion loss. In some examples, the diffusion prior model 525 is trained separately from the image generation model 530.

In one aspect, training component 540 includes aesthetic classifier 545 and style classifier 550. In some aspects, aesthetic classifier 545 is implemented as software stored in memory unit 515 and executable by processor unit 505, as firmware, as one or more hardware circuits, or as a combination thereof. According to some embodiments, aesthetic classifier 545 is implemented as software stored in a memory unit and executable by a processor in the processor unit of a separate computing device, as firmware in the separate computing device, as one or more hardware circuits of the separate computing device, or as a combination thereof. In some examples, aesthetic classifier 545 is part of another apparatus other than image processing apparatus 500 and communicates with the image processing apparatus 500. In some examples, aesthetic classifier 545 is part of image processing apparatus 500.

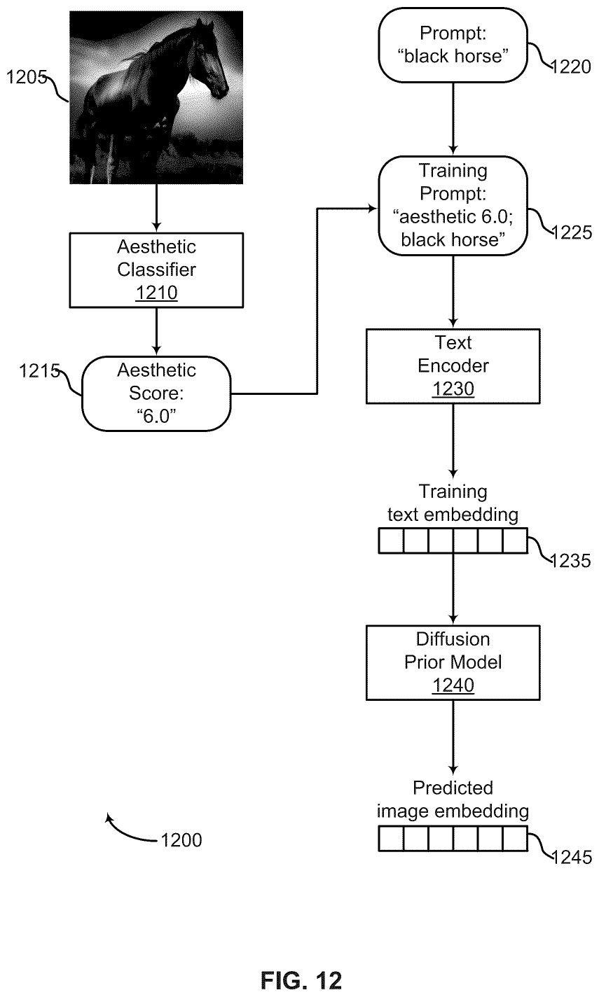

According to some aspects, aesthetic classifier 545 computes the image quality level based on the training image. According to some aspects, aesthetic classifier 545 is configured to compute the image quality level. Aesthetic classifier 545 is an example of, or includes aspects of, the corresponding element described with reference to FIG. 12.

According to some aspects, style classifier 550 is implemented as software stored in memory unit 515 and executable by processor unit 505, as firmware, as one or more hardware circuits, or as a combination thereof. According to some embodiments, style classifier 550 is implemented as software stored in a memory unit and executable by a processor in the processor unit of a separate computing device, as firmware in the separate computing device, as one or more hardware circuits of the separate computing device, or as a combination thereof. In some examples, style classifier 550 is part of another apparatus other than image processing apparatus 500 and communicates with the image processing apparatus 500. In some examples, style classifier 550 is part of image processing apparatus 500. According to some aspects, style classifier 550 is configured to compute a value indicating a level of a style, where the input prompt includes the level of the style.

FIG. 6 shows an example of a machine learning model according to aspects of the present disclosure. The example shown includes machine learning system 600, input prompt 605, text encoder 610, text embedding 615, diffusion prior model 620, image embedding 625, image generation model 630, and synthetic image 635.

Referring to FIG. 6, machine learning system 600 receives input prompt 605 to generate synthetic image 635. For example, text encoder 610 receives input prompt 605 to generate text embedding 615. In some cases, input prompt 605 states “aesthetic 8.0; black horse”. In some cases, a preliminary prompt and a value of the image quality are provided to text encoder 610. For example, the preliminary prompt states “black horse” and the value of the image quality is “8.0”. Then, machine learning system 600 combines the preliminary prompt and the value to obtain input prompt 605. In some cases, for example, input prompt 605 is obtained using the string “aesthetic <val>; <prompt>”. In some cases, for example, input prompt 605 is obtained using the string “aesthetic <score with a single decimal digit>; <color><animal name>”.

In some embodiments, input prompt 605 includes an additional style input that describes the style of the image to be generated. For example, to constrain the image generation process to vector-like images, a vector classifier score can be prepended to input prompt 605. For example, the modified input prompt may state “vector 0.6; aesthetic 8.0; black horse”. Accordingly, the output image depicts vector-like contents of the black horse having a high aesthetic appearance.

In some aspects, text encoder 610 is used in natural language processing (NLP) tasks as text encoder 610 transforms raw text data (e.g., input prompt 605) into a format that can be utilized by algorithms for tasks such as classification, translation, sentiment analysis, etc. In one aspect, text embedding 615 includes information about input prompt 605 and is encoded in a vector space.

In some embodiments, diffusion prior model 620 is trained to convert text embedding 615 to image embedding 625. In some cases, diffusion prior model 620 converts the semantic and syntactic information in text embedding 615 to visual features in image embedding 625. Compared to the information captured in text embedding 615, image embedding 625 captures complex visual information such as the visual appearance of objects, scenes, and spatial arrangement of elements in an image. In some aspects, image embedding 625 is in a higher dimension than text embedding 615. In some cases, text embedding 615 falls short in conveying visual details. In contrast, image embedding 625 includes rich visual information such as color, shape, object identity, spatial relationships, etc. In some aspects, text embedding 615 and image embedding 625 are in the same multi-modal vector space.

In some aspects, diffusion prior model 620 is trained to convert from textual descriptions to visual representations. For example, diffusion prior model 620 maps the semantic information captured in text embedding 615 into the visual space of image embedding 625. In some cases, diffusion prior model 620 includes a diffusion model that learns to transform text embedding 615 into image embedding 625 through a plurality of iterative diffusion steps. In some cases, for example, noise is progressively added to image embedding 625 during a forward diffusion step. Then, during the reverse diffusion step, noise is iteratively removed and diffusion prior model 620 removes noise from the noisy embedding to reconstruct image embedding 625 conditioned based on text embedding 615. In some cases, for example, text embedding 615 is used in cross-attention during the forward diffusion process.

In some embodiments, image generation model 630 receives image embedding 625 to generate synthetic image 635. For example, synthetic image 635 depicts a black horse having a high aesthetic appearance. In some cases, synthetic image 635 has a high resolution, sharp edges, bright color contrast, good composition, and high image detail. By generating synthetic image 635 using image embedding 625, image generation model 630 is able to accurately generate synthetic images that align with the textual description (e.g., input prompt 605).

In some aspects, image generation model 630 includes a diffusion model configured to generate realistic images from various inputs such as random noise, text input, an image input, or style input. In some cases, image generation model 630 starts with random noise and gradually removes noise to generate a clean image (e.g., synthetic image 635). In some cases, the reverse diffusion process may be guided using guidance vectors such as a text prompt (or a text embedding), an image embedding (or an image feature), or a style prompt. Further detail on image generation model 630 is described with reference to FIG. 7.

Input prompt 605 is an example of, or includes aspects of, the corresponding element described with reference to FIG. 3. Text encoder 610 is an example of, or includes aspects of, the corresponding element described with reference to FIGS. 5, 7, 12, and 13. Diffusion prior model 620 is an example of, or includes aspects of, the corresponding element described with reference to FIGS. 5, 12, and 13.

Image generation model 630 is an example of, or includes aspects of, the corresponding element described with reference to FIGS. 5 and 13. Image generation model 630 is an example of, or includes aspects of, the diffusion model described with reference to FIG. 7. Synthetic image 635 is an example of, or includes aspects of, the corresponding element described with reference to FIG. 13.

FIG. 7 shows an example of an image generation model according to aspects of the present disclosure. The example shown includes diffusion model 700, original image 705, pixel space 710, image encoder 715, original image feature 720, latent space 725, forward diffusion process 730, noisy feature 735, reverse diffusion process 740, denoised image feature 745, image decoder 750, output image 755, text prompt 760, text encoder 765, guidance feature 770, and guidance space 775. According to some aspects, diffusion model 700 is a guided latent diffusion model. In some examples, diffusion model 700 describes the operation and architecture of the image generation model 530 described with reference to FIG. 5.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 700 may take an original image 705 in a pixel space 710 as input and apply an image encoder 715 to convert original image 705 into original image feature 720 in a latent space 725. Then, a forward diffusion process 730 gradually adds noise to the original image feature 720 to obtain noisy feature 735 (also in latent space 725) at various noise levels.

Next, a reverse diffusion process 740 (e.g., a U-Net ANN) gradually removes the noise from the noisy feature 735 at the various noise levels to obtain the denoised image feature 745 in latent space 725. In some examples, denoised image feature 745 is compared to the original image feature 720 at each of the various noise levels, and parameters of the reverse diffusion process 740 of the diffusion model are updated based on the comparison. Finally, an image decoder 750 decodes the denoised image feature 745 to obtain an output image 755 in pixel space 710. In some cases, an output image 755 is created at each of the various noise levels. The output image 755 can be compared to the original image 705 to train the reverse diffusion process 740. In some cases, output image 755 refers to the synthetic image (e.g., described with reference to FIGS. 3 and 6).

In some cases, image encoder 715 and image decoder 750 are pre-trained prior to training the reverse diffusion process 740. In some examples, image encoder 715 and image decoder 750 are trained jointly, or the image encoder 715 and image decoder 750 are fine-tuned jointly with the reverse diffusion process 740.

The reverse diffusion process 740 can also be guided based on a text prompt 760, or another guidance prompt, such as an image, a layout, a style, a color, a segmentation map, etc. The text prompt 760 can be encoded using a text encoder 765 (e.g., a multimodal encoder) to obtain guidance feature 770 in guidance space 775. The guidance feature 770 can be combined with the noisy feature 735 at one or more layers of the reverse diffusion process 740 to ensure that the output image 755 includes content described by the text prompt 760. For example, guidance feature 770 can be combined with the noisy feature 735 using a cross-attention block within the reverse diffusion process 740.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt (e.g., text prompt 760) describing content to be included in a generated image. In some examples, guidance can be provided in a form other than text, such as via an image, a sketch, a color, a style, or a layout. The system converts text prompt 760 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 700 generates an image based on the noise map and the conditional guidance vector.

A diffusion process can include both a forward diffusion process 730 for adding noise to an image (e.g., original image 705) or features (e.g., original image feature 720) in a latent space 725 and a reverse diffusion process 740 for denoising the images (or features) to obtain a denoised image (e.g., output image 755). The forward diffusion process 730 can be represented as q(xₜ|xₜ₋₁), and the reverse diffusion process 740 can be represented as p_{θ}(xₜ₋₁|xₜ). Further detail on the diffusion process is described with reference to FIG. 9.

A diffusion model 700 may be trained using both a forward diffusion process 730 and a reverse diffusion process 740. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 730 in N stages. In some cases, the forward diffusion process 730 is a fixed process where Gaussian noise is successively added to an image. In latent diffusion models, the Gaussian noise may be successively added to features (e.g., original image feature 720) in a latent space 725.

At each stage n, starting with stage N, a reverse diffusion process 740 is used to predict the image or image features at stage n−1. For example, the reverse diffusion process 740 can predict the noise that was added by the forward diffusion process 730, and the predicted noise can be removed from the image to obtain the predicted image. In some cases, an original image 705 is predicted at each stage of the training process.

The training component (e.g., training component described with reference to FIG. 6) compares predicted image (or image features) at stage n−1 to an actual image (or image features), such as the image at stage n−1 or the original input image. For example, given observed data x, the diffusion model 700 may be trained to minimize the variational upper bound of the negative log-likelihood −log p_{θ}(x) of the training data. The training component then updates parameters of the diffusion model 700 based on the comparison. For example, parameters of a U-Net may be updated using gradient descent. Time-dependent parameters of the Gaussian transitions can also be learned.

Original image 705 is an example of, or includes aspects of, the corresponding element described with reference to FIG. 9. Forward diffusion process 730 is an example of, or includes aspects of, the corresponding element described with reference to FIG. 9. Reverse diffusion process 740 is an example of, or includes aspects of, the corresponding element described with reference to FIG. 9. Text encoder 765 is an example of, or includes aspects of, the corresponding element described with reference to FIGS. 5, 6, 12, and 13.

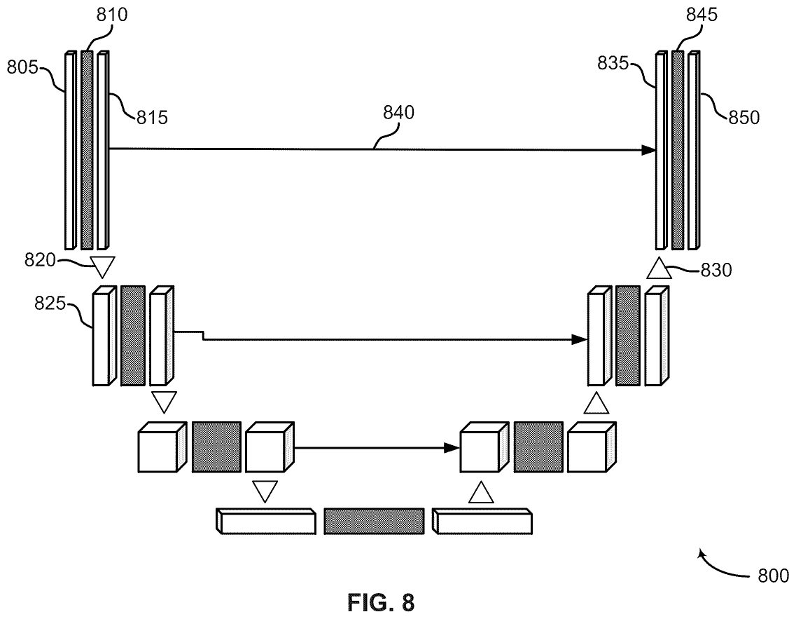

FIG. 8 shows an example of a U-Net 800 architecture according to aspects of the present disclosure. The example shown includes U-Net 800, input feature 805, initial neural network layer 810, intermediate feature 815, down-sampling layer 820, down-sampled feature 825, up-sampling process 830, up-sampled feature 835, skip connection 840, final neural network layer 845, and output feature 850.

In some examples, U-Net 800 is an example of the component that performs the reverse diffusion process 740 of diffusion model 700 described with reference to FIG. 7 and includes architectural elements of the image generation model 530 described with reference to FIG. 5. The U-Net 800 depicted in FIG. 8 is an example of, or includes aspects of, the architecture used within the reverse diffusion process described with reference to FIG. 7.

In some examples, diffusion models are based on a neural network architecture known as a U-Net. The U-Net 800 takes input feature 805 having an initial resolution and an initial number of channels, and processes the input feature 805 using an initial neural network layer 810 (e.g., a convolutional network layer) to produce intermediate feature 815. The intermediate feature 815 is then down-sampled using a down-sampling layer 820 such that the down-sampled feature 825 has a resolution less than the initial resolution and a number of channels greater than the initial number of channels.

This process is repeated multiple times, and then the process is reversed. For example, the down-sampled feature 825 is up-sampled using up-sampling process 830 to obtain up-sampled feature 835. The up-sampled feature 835 can be combined with intermediate feature 815 having the same resolution and number of channels via a skip connection 840. These inputs are processed using a final neural network layer 845 to produce output feature 850. In some cases, the output feature 850 has the same resolution as the initial resolution and the same number of channels as the initial number of channels.

In some cases, U-Net 800 takes an additional input feature to produce conditionally generated output. For example, the additional input feature could include a vector representation of an input prompt. The additional input feature can be combined with the intermediate feature 815 within the neural network at one or more layers. For example, a cross-attention module can be used to combine the additional input features and the intermediate feature 815.

### Diffusion Process

FIG. 9 shows an example of a diffusion process 900 according to aspects of the present disclosure. The example shown includes diffusion process 900, forward diffusion process 905, reverse diffusion process 910, noisy image 915, first intermediate image 920, second intermediate image 925, and original image 930.

Diffusion process 900 can include forward diffusion process 905 for adding noise to original image 930 (e.g., original image 705 described with reference to FIG. 7) or features (e.g., original image feature 720 described with reference to FIG. 7) in a latent space. In some aspects, diffusion process 900 includes reverse diffusion process 910 for denoising the noisy image 915 (or image features) to obtain a denoised image (or original image 930). The forward diffusion process 905 can be represented as q(xₜ|xₜ₋₁), and the reverse diffusion process 910 can be represented as p_{θ}(xₜ₋₁|xₜ). In some cases, the forward diffusion process 905 is used during training to generate images with successively greater noise, and a neural network is trained to perform the reverse diffusion process 910 (e.g., to successively remove the noise).

In an example forward diffusion process 905 for a latent diffusion model (e.g., diffusion model 700 described with reference to FIG. 7), the diffusion model maps an observed variable x₀ (either in a pixel space or a latent space) to obtain intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 910. During the reverse diffusion process 910, the diffusion model begins with noisy data x_{T}, such as a noisy image 915 and denoises the data to obtain the p_{θ}(xₜ₋₁|xₜ). At each step t−1, the reverse diffusion process 910 takes xₜ, such as the first intermediate image 920, and t as input. Here, t represents a step in the sequence of transitions associated with different noise levels, The reverse diffusion process 910 outputs xₜ₋₁, such as the second intermediate image 925, iteratively until x_{T} is reverted back to x₀, the original image 930. The reverse diffusion process 910 can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0,1) is the pure noise distribution as the reverse diffusion process 910 takes the outcome of the forward diffusion process 905, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and x represents the generated image with high image quality.

Forward diffusion process 905 is an example of, or includes aspects of, the corresponding element described with reference to FIG. 7. Reverse diffusion process 910 is an example of, or includes aspects of, the corresponding element described with reference to FIG. 7. Original image 930 is an example of, or includes aspects of, the corresponding element described with reference to FIG. 7.

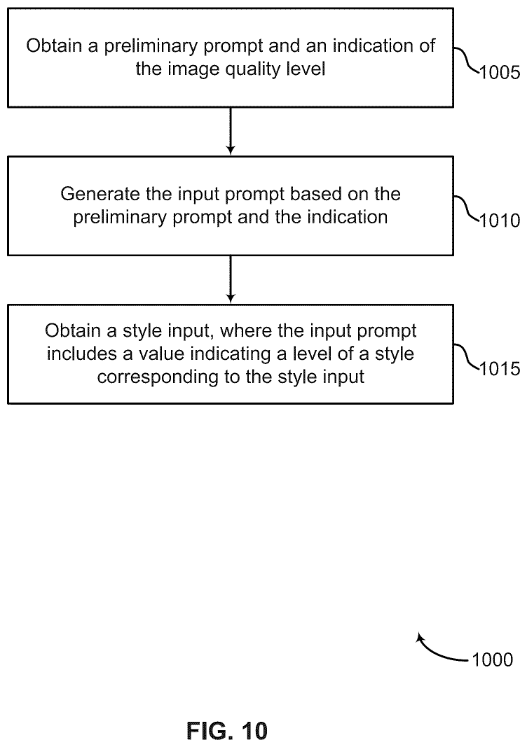

FIG. 10 shows an example of a method 1000 for obtaining an input prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system obtains a preliminary prompt and an indication of the image quality level. In some cases, the operations of this step refer to, or may be performed by, a text encoder as described with reference to FIGS. 5-7, 12, and 13. In some cases, a preliminary prompt describes the content to be generated in a synthetic image. In some cases, the indication of the image quality level includes a value of an aesthetic score. For example, the aesthetic score is determined based on visual appearance factors such as the visual appearance of an image such as resolution, composition, mood, theme, color, lighting, texture, focus, contrast, style, and/or context.

At operation 1010, the system generates the input prompt based on the preliminary prompt and the indication. In some cases, the operations of this step refer to, or may be performed by, a text encoder as described with reference to FIGS. 5-7, 12, and 13. In some cases, the machine learning model combines the preliminary prompt and the indication to obtain the input prompt. For example, input prompt may be represented as the aesthetic score followed by the preliminary prompt, or vice versa.

At operation 1015, the system obtains a style input, where the input prompt includes a value indicating a level of a style corresponding to the style input. In some cases, the operations of this step refer to, or may be performed by, a text encoder as described with reference to FIGS. 5-7, 12, and 13. In some cases, the style input describes the style of the image to be generated. For example, to constrain the image generation process to vector-like images, a vector classifier score can be prepended to input prompt 605. In some cases, the style input may include other types of styles such as cartoon style, painting style, etc.

### Training and Evaluation

In FIGS. 11-15, a method, apparatus, non-transitory computer readable medium, and system for image processing include obtaining a training set comprising a training image and a training prompt that includes an image quality level, generating, using an image generation model, a synthetic image based on the training prompt, and training, using the training set and the synthetic image, a diffusion prior model to generate an image embedding that represents the image quality level.

Some examples of the method, apparatus, non-transitory computer readable medium, and system further include obtaining a preliminary prompt and the image quality level. Some examples further include generating the training prompt based on the preliminary prompt and the image quality level. Some examples of the method, apparatus, non-transitory computer readable medium, and system further include obtaining a style input, where the training prompt includes a value indicating a level of a style corresponding to the style input.

Some examples of the method, apparatus, non-transitory computer readable medium, and system further include computing the image quality level based on the training image. Some examples of the method, apparatus, non-transitory computer readable medium, and system further include generating a text embedding based on the training prompt. Some examples further include generating an estimated image embedding based on the text embedding. Some examples further include generating the synthetic image based on the estimated image embedding.

Some examples of the method, apparatus, non-transitory computer readable medium, and system further include computing a diffusion loss based on the synthetic image. Some examples further include updating parameters of the diffusion prior model based on the diffusion loss. In some examples, the diffusion prior model is trained separately from the image generation model.

FIG. 11 shows an example of a method 1100 for training a diffusion prior model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1105, the system obtains a training set including a training image and a training prompt that includes an image quality level. In some cases, the operations of this step refer to, or may be performed by, a training component as described with reference to FIG. 5. In some cases, for example, the training data may be stored in a database (e.g., the database described with reference to FIG. 1). For example, the training data may include a training image and a corresponding training prompt that describes the training image. For example, the training prompt includes a description of the content depicted in the training image and a corresponding image quality level. In some cases, the image quality level includes an aesthetic score that represents the visual appearance of the training image. In some cases, an aesthetic classifier is used to obtain the aesthetic score.

At operation 1110, the system generates a synthetic image based on the training prompt. In some cases, the operations of this step refer to, or may be performed by, an image generation model as described with reference to FIGS. 5, 6, and 13. In some cases, the image generation model is pre-trained to generate the synthetic image based on the training prompt. For example, a text encoder is configured to generate a training text embedding based on the training prompt. Then, a diffusion prior model is configured to generate a training image embedding based on the training text embedding. Then, the image generation model is configured to generate a synthetic image based on the training image embedding.

At operation 1115, the system trains, using the training set and the synthetic image, a diffusion prior model to generate an image embedding that represents the image quality level. In some cases, the operations of this step refer to, or may be performed by, a training component as described with reference to FIG. 5. In some cases, the diffusion prior model is trained to generate an image embedding based on the training prompt. For example, the diffusion prior model is trained to generate image embedding that includes visual information of the image to be generated from the semantic information in the text embedding. In some cases, the diffusion prior model is training using upside-down reinforcement learning described with reference to FIG. 12.

FIG. 12 shows an example of upside-down reinforcement learning (UDRL) according to aspects of the present disclosure. The example shown includes training system 1200, training image 1205, aesthetic classifier 1210, aesthetic score 1215, preliminary prompt 1220, training prompt 1225, text encoder 1230, training text embedding 1235, diffusion prior model 1240, and predicted image embedding 1245.

In the field of machine learning, and more particularly in learning paradigms, reinforcement learning (RL) is one of three basic machine learning paradigms, alongside supervised learning and unsupervised learning. For example, RL relates to how software agents make decisions to maximize a reward. The decision-making model may be referred to as a policy. This type of learning differs from supervised learning in that labeled training data is not needed, and errors need not be explicitly corrected. Instead, RL balances the exploration of unknown options and the exploitation of existing knowledge. In some cases, the reinforcement learning environment is stated in the form of a Markov decision process (MDP). Furthermore, many reinforcement learning algorithms utilize dynamic programming techniques. However, a difference between reinforcement learning and other dynamic programming methods is that RL does not require an exact mathematical model of the MDP. Therefore, reinforcement learning models may be used for large MDPs where exact methods are impractical. In some cases, RL can be used in image segmentation, image enhancement or restoration, object detection or recognition, and image generation.

In upside-down reinforcement learning (UDRL), the agent learns to predict actions that achieve desired outcomes based on past experiences and specified goals. In some cases, UDRL is similar to supervised learning, where UDRL focuses on learning from examples where specific actions lead to the desired outcomes. In some cases, UDRL can be seen as an extension of behavior cloning, where the agent learns from examples or trajectories that specify both states and desired returns instead of purely mimicking actions.

Referring to FIG. 12, the training system 1200 is trained using the UDRL technique. For example, diffusion prior model 1240 learns to estimate a predicted image embedding 1245 based on training image 1205 and preliminary prompt 1220. First, aesthetic classifier 1210 extracts an aesthetic score 1215 from training image 1205. Then, preliminary prompt 1220 is combined with aesthetic score 1215 to obtain training prompt 1225. For example, training prompt 1225 states “aesthetic score 6.0; black horse”. In one aspect, training prompt 1225 includes content and an image quality level corresponding to training image 1205. Then, text encoder 1230 is configured to generate training text embedding 1235 based on training prompt 1225.

In some embodiments, diffusion prior model 1240 is trained to generate a predicted image embedding 1245 from training text embedding 1235. In some cases, predicted image embedding 1245 includes information relevant to training prompt 1225. In some cases, predicted image embedding 1245 includes visual information of the content described by preliminary prompt 1220 and the corresponding image quality level from training image 1205. Accordingly, diffusion prior model 1240 directly learns the outcome (e.g., predicted image embedding 1245) from past experience or example (e.g., training image 1205 and preliminary prompt 1220). As a result, an image generation model can generate an accurate image based on the predicted image embedding 1245 including accurate information of the content and image quality level.

Training system 1200 is an example of, or includes aspects of, the corresponding element described with reference to FIG. 13. Aesthetic classifier 1210 is an example of, or includes aspects of, the corresponding element described with reference to FIG. 5. Text encoder 1230 is an example of, or includes aspects of, the corresponding element described with reference to FIGS. 5-7, and 13.

Training text embedding 1235 is an example of, or includes aspects of, the corresponding element described with reference to FIG. 13. Diffusion prior model 1240 is an example of, or includes aspects of, the corresponding element described with reference to FIGS. 5, 6, and 13. Predicted image embedding 1245 is an example of, or includes aspects of, the corresponding element described with reference to FIG. 13.

FIG. 13 shows an example of training a diffusion prior model according to aspects of the present disclosure. The example shown includes training system 1300, training set 1305, text encoder 1310, training text embedding 1315, diffusion prior model 1320, predicted image embedding 1325, image generation model 1330, synthetic image 1335, ground-truth image 1340, and loss 1345.

Referring to FIG. 13, training system 1300 trains diffusion prior model 1320 based on a training set 1305. For example, training set 1305 includes a training image and a training prompt stored in a database (e.g., the database described with reference to FIG. 1). In some cases, text encoder 1310 receives the training prompt to generate training text embedding 1315. Then, diffusion prior model 1320 receives training text embedding 1315 to generate predicted image embedding 1325. Then, image generation model 1330 receives predicted image embedding 1325 to generate synthetic image 1335. In some cases, training system 1300 computes loss 1345 based on synthetic image 1335 and ground-truth image 1340 from training set 1305. The loss 1345 is used to train and update parameters of diffusion prior model 1320.

In some embodiments, loss 1345 may include a cross-entropy loss, a mean squared error (MSE), a perceptual loss, or an adversarial loss. In some embodiments, the training system 1300 computes a diffusion loss based on the synthetic image 1335 and the ground-truth image 1340. For example, the diffusion loss is a mean squared error (MSE) measured between the actual noise and the predicted noise at a sampled time t. In some cases, the MSE may be referred to as the L2 loss. In some embodiments, the MSE is calculated using a training image embedding and the synthetic image embedding at each step of the reverse diffusion process. In some cases, the diffusion loss includes a mean absolute error (MAE). In some cases, the MAE is referred to as the L1 loss. In some cases, the parameters of the image generation model are updated based on the diffusion loss.

Training system 1300 is an example of, or includes aspects of, the corresponding element described with reference to FIG. 12. Text encoder 1310 is an example of, or includes aspects of, the corresponding element described with reference to FIGS. 5-7, and 12. Training text embedding 1315 is an example of, or includes aspects of, the corresponding element described with reference to FIG. 12.

Diffusion prior model 1320 is an example of, or includes aspects of, the corresponding element described with reference to FIGS. 5, 6, and 12. Predicted image embedding 1325 is an example of, or includes aspects of, the corresponding element described with reference to FIG. 12. Image generation model 1330 is an example of, or includes aspects of, the corresponding element described with reference to FIGS. 5 and 6. Synthetic image 1335 is an example of, or includes aspects of, the corresponding element described with reference to FIG. 6.

FIG. 14 shows an example flowchart diagram illustrating an algorithm as a step-by-step procedure in an example implementation of operations performable for training a machine learning model according to aspects of the present disclosure. In some embodiments, the procedure 1400 describes an operation of the training component 540 described for configuring the diffusion prior model 525 as described with reference to FIG. 5. The procedure 1400 provides one or more examples of generating training data, use of the training data to train a machine-learning model, and use of the trained machine-learning model to perform a task.

To begin in this example, a machine-learning system collects training data (block 1402) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1404) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1406). Initialization of the machine-learning model includes selecting a model architecture (block 1408) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1410). The loss function is utilized to measure a difference between an output of the machine-learning model (e.g., the model predictions) and target values (e.g., as expressed by the training data) to be used to train the machine-learning model. Additionally, an optimization algorithm is selected (block 1412) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1414) examples of which include initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1418) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1420), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1420), procedure 1400 continues the training of the machine-learning model using the training data (block 1418) in this example.

If the stopping criterion is met (“yes” from decision block 1420), the trained machine-learning model is then utilized to generate an output based on subsequent data (block 1422). The trained machine-learning model, for instance, is trained to perform a task as described above and therefore once trained is configured to perform that task based on subsequent data received as an input and processed by the machine-learning model.

FIG. 15 shows an example of a method 1500 for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In some embodiments, the method 1500 describes an operation of the training component 540 described for configuring the diffusion prior model 525 as described with reference to FIG. 5. The method 1500 represents an example for training a reverse diffusion process as described above with reference to FIG. 9. In some examples, these operations are performed by a system including a processor executing a set of codes to control functional elements of an apparatus, such as the guided diffusion model described in FIG. 7.

At operation 1505, the system initializes an untrained model. In some cases, the operations of this step refer to, or may be performed by, a training component as described with reference to FIG. 5. Initialization can include defining the architecture of the model and establishing initial values for the model parameters. In some cases, the initialization can include defining hyper-parameters such as the number of layers, the resolution and channels of each layer block, the location of skip connections, and the like.

At operation 1510, the system adds noise to a media item using a forward diffusion process in N stages. In some cases, the operations of this step refer to, or may be performed by, a training component as described with reference to FIG. 5. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1515, the system at each stage n, starting with stage N, predicts a media item for stage n−1 using a reverse diffusion process. In some cases, the operations of this step refer to, or may be performed by, a training component as described with reference to FIG. 5. In some cases, the media item is a synthetic image generated using the image generation model. For example, the reverse diffusion process can predict the noise that was added by the forward diffusion process, and the predicted noise can be removed from the noise input to obtain the predicted output. In some cases, an original media item is predicted at each stage of the training process.

At operation 1520, the system compares the predicted media item (or feature) at stage n−1 to media at stage n−1. In some cases, for example, the system compares the synthetic image (or predicted image feature) at state n−1 to the ground-truth image (or ground-truth feature) at state n−1. In some cases, the operations of this step refer to, or may be performed by, a training component as described with reference to FIG. 5. For example, given observed data x, the diffusion model may be trained to minimize the variational upper bound of the negative log-likelihood −log p_{θ}(x) of the training data.

At operation 1525, the system updates parameters of the model based on the comparison. In some cases, the operations of this step refer to, or may be performed by, a training component as described with reference to FIG. 5. For example, parameters of a U-Net may be updated using gradient descent. Time-dependent parameters of the Gaussian transitions can also be learned.

### Computing Device

FIG. 16 shows an example of a computing device 1600 according to aspects of the present disclosure. The example shown includes computing device 1600, processor 1605, memory subsystem 1610, communication interface 1615, I/O interface 1620, user interface component 1625, and channel 1630.

In some embodiments, computing device 1600 is an example of, or includes aspects of, the image processing apparatus described with reference to FIGS. 1 and 5. In some embodiments, computing device 1600 includes processor 1605 that can execute instructions stored in memory subsystem 1610 to obtain an input prompt including an image quality level and a description of an object, generate an image embedding based on the input prompt, and generate a synthetic image based on the image embedding.

According to some embodiments, processor 1605 includes one or more processors. In some cases, processor 1605 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1605 is configured to operate a memory array using a memory controller. In other cases, a memory controller is integrated into processor 1605. In some cases, processor 1605 is configured to execute computer-readable instructions stored in a memory to perform various functions. In some embodiments, processor 1605 includes special-purpose components for modem processing, baseband processing, digital signal processing, or transmission processing. Processor 1605 is an example of, or includes aspects of, the processor unit described with reference to FIG. 5.

According to some embodiments, memory subsystem 1610 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1610 is an example of, or includes aspects of, the memory unit described with reference to FIG. 5.

According to some embodiments, communication interface 1615 operates at a boundary between communicating entities (such as computing device 1600, one or more user devices, a cloud, and one or more databases) and channel 1630 and can record and process communications. In some cases, communication interface 1615 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1615.

According to some embodiments, I/O interface 1620 is controlled by an I/O controller to manage input and output signals for computing device 1600. In some cases, I/O interface 1620 manages peripherals not integrated into computing device 1600. In some cases, I/O interface 1620 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1620 or hardware components controlled by the I/O controller. I/O interface 1620 is an example of, or includes aspects of, the I/O module described with reference to FIG. 5.

According to some embodiments, user interface component 1625 enables a user to interact with computing device 1600. In some cases, user interface component 1625 includes an audio device, such as an external speaker system, an external display device such as a display screen, an input device (e.g., a remote-control device interfaced with a user interface directly or through the I/O controller), or a combination thereof. User interface component 1625 is an example of, or includes aspects of, the user interface described with reference to FIG. 5.

The performance of apparatus, systems, and methods of the present disclosure have been evaluated, and results indicate embodiments of the present disclosure have obtained increased performance over existing technology (e.g., conventional image generation models). Example experiments demonstrate that the image processing apparatus based on the present disclosure outperforms conventional image generation models. Details on the example use cases based on embodiments of the present disclosure are described with reference to FIG. 3.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt including an image quality level and a description of an object;
generating, using a diffusion prior model, an image embedding based on the input prompt, wherein the image embedding represents the object and the image quality level in a vector space; and
generating, using an image generation model, a synthetic image based on the image embedding, wherein the synthetic image depicts the object and has the image quality level.

2. The method of claim 1, wherein obtaining the input prompt comprises:
obtaining a preliminary prompt and an indication of the image quality level; and
generating the input prompt based on the preliminary prompt and the indication.

3. The method of claim 1, wherein obtaining the input prompt comprises:
obtaining a style input, wherein the input prompt includes a value indicating a level of a style corresponding to the style input.

4. The method of claim 1, further comprising:
generating a text embedding based on the input prompt, wherein the image embedding is generated based on the text embedding.

5. The method of claim 1, wherein generating the synthetic image comprises:
obtaining a noise map; and
denoising the noise map based on the image embedding to generate the synthetic image.

6. The method of claim 1, wherein:
the diffusion prior model is trained to generate image embeddings using a training set comprising a training image and a training prompt that includes the image quality level.

7. A method comprising:
obtaining a training set comprising a training image and a training prompt that includes an image quality level;
generating, using an image generation model, a synthetic image based on the training prompt; and
training, using the training set and the synthetic image, a diffusion prior model to generate an image embedding that represents the image quality level.

8. The method of claim 7, wherein obtaining the training set comprises:
obtaining a preliminary prompt and the image quality level; and
generating the training prompt based on the preliminary prompt and the image quality level.

9. The method of claim 7, wherein obtaining the training set comprises:
obtaining a style input, wherein the training prompt includes a value indicating a level of a style corresponding to the style input.

10. The method of claim 7, wherein obtaining the training set comprises:
computing the image quality level based on the training image.

11. The method of claim 7, wherein training the diffusion prior model comprises:
generating a text embedding based on the training prompt;
generating an estimated image embedding based on the text embedding; and
generating the synthetic image based on the estimated image embedding.

12. The method of claim 7, wherein training the diffusion prior model comprises:
computing a diffusion loss based on the synthetic image; and
updating parameters of the diffusion prior model based on the diffusion loss.

13. The method of claim 7, wherein:
the diffusion prior model is trained separately from the image generation model.

14. An apparatus comprising:
at least one processor;
at least one memory storing instructions executable by the at least one processor;
a diffusion prior model comprising parameters stored in the at least one memory and trained to generate an image embedding based on an input prompt including an image quality level and a description of an object, wherein the image embedding represents the object and the image quality level in a vector space; and
an image generation model comprising parameters stored in the at least one memory and configured to generate a synthetic image based on the image embedding, wherein the synthetic image depicts the object and has the image quality level.

15. The apparatus of claim 14, further comprising:
a text encoder configured to generate a text embedding based on the input prompt, wherein the image embedding is generated based on the text embedding.

16. The apparatus of claim 14, further comprising:
an aesthetic classifier configured to compute the image quality level.

17. The apparatus of claim 14, further comprising:
a style classifier configured to compute a value indicating a level of a style, wherein the input prompt includes the level of the style.

18. The apparatus of claim 14, wherein:
the diffusion prior model includes a diffusion model.

19. The apparatus of claim 14, wherein:
the image generation model includes a diffusion model.

20. The apparatus of claim 14, further comprising:
a user interface configured to obtain a preliminary prompt, wherein the input prompt is based on the preliminary prompt and the image quality level.
